(19) United States
(12) Patent Application Publication
(10) Pub. No.: US 2024/0375047 A1
(43) Pub. Date: Nov. 14, 2024

(54) METHODS AND COMPOSITIONS FOR CARBON CAPTURE

(71) Applicant: Entropy Inc., Calgary (CA)

(72) Inventors: Raphael IDEM, Regina (CA); Teeradet SUPAP, Regina (CA); Jessica NARKU-TETTEH, Regina (CA); Pailin MUCHAN, Regina (CA); Paweesuda NATEWONG, Regina (CA)

(73) Assignee: Entropy Inc., Calgary, AB (CA)

(21) Appl. No.: 18/647,433

(22) Filed: Apr. 26, 2024

(30) Foreign Application Priority Data
Apr. 28, 2023 (CA) 3198153

(51) Int. Cl. B01D 53/78; B01D 53/62

(52) U.S. Cl. CPC B01D 53/78; B01D 53/62; B01D 2252/2041; B01D 2252/20468; B01D 2252/504; B01D 2257/504; B01D 2258/0283

(57) ABSTRACT

A solvent composition for carbon capture is provided. According to a preferred embodiment, the solvent used for carbon capture comprises: (a) a first component selected from the group consisting of: diethylaminoethanol; 1-(2-hydroxhyl) pyrrolidine; 3-diethylamino-1,2-propanediol; 3-diethylamino-1-propanol; 1-diethylamino-2-propanol and combinations thereof; and (b) a second component selected from the group consisting of: hexamethylenediamine (HMDA); 4-amino-1-butanol and combinations thereof. A method of performing carbon capture using the carbon capture solvent compositions described herein is also provided. An apparatus for performing carbon capture using the carbon capture compositions described herein and/or the carbon capture methods described herein is also provided.

### CROSS-REFERENCE TO RELATED APPLICATIONS

This application claims priority under 35 U.S.C. § 119 to Canadian Patent Application No. 3198153, filed on Apr. 28, 2023, in the Canadian Intellectual Property Office, the disclosure of which is incorporated by reference herein in its entirety.

### FIELD OF INVENTION

This present disclosure is directed to methods and compositions for carbon capture, more specifically, there is disclosed various solvent compositions used in carbon capture and methods of using such.

### BACKGROUND OF THE INVENTION

Carbon capture using aqueous amine solutions with chemical reaction has been adapted for treating dilute and low-pressure flue gases released from industrial processes. However, current amine-based carbon capture processes have several drawbacks. One drawback is the inability to provide high absorption and desorption rates of CO₂. Another drawback is the inability to achieve high CO₂ capture capacity while consuming a very small heat duty. Other drawbacks are specific to the type of amine used.

For example, primary amines such as monoethanolamine (MEA) form a very stable carbamate with CO₂ which requires a high regeneration energy in its break-down process. As another example, secondary amines such as diethanolamine (DEA) can directly react with NOx, a common impurity in fossil fuel fired flue gas, emitting potentially toxic nitrosamines with the off-gas. Tertiary amines such as methyldiethanolamine require less heat for regeneration compared to the other amines, but they still suffer from having a slow rate of reaction with CO₂, thus affecting the capture performance in terms of kinetics. Polyamines, such as piperazine (PZ), poses a threat because it is a secondary amine which can form nitrosamine emissions. All of these drawbacks can hinder the carbon capture process.

In addition, issues like amine loss by degradation, off-gas emission, amine volatilization, amine corrosion, and amine foaming often plague the carbon capture process. These operational issues can prevent a capture plant from achieving the original design conditions and performance goals. Emissions of degradation products can jeopardize an amine-based CO₂ capture plant itself by creating the possibility of unscheduled down times or even forcing the plant to shut down unnecessarily due to the plant being too toxic to continue to operate.

Therefore, there is a need to improve the efficiency associated with using amines and/or amine-based solutions in carbon capture, especially for treating dilute and low-pressure flue gases released from industrial processes. In particular, there is a need to develop new amine solvents that have one or more of the following desirable CO₂ capture properties: high absorption, high cyclic capacity, fast reaction kinetics, low corrosion, low degradation, low volatility, and satisfactory heat duty requirements for solvent regeneration.

### SUMMARY OF THE INVENTION

According to one aspect of the present invention, there is described methods and compositions for carbon capture. In some embodiments, the methods and compositions may be applied to capture carbon dioxide from the exhaust stream of hydrocarbon burning emitters.

According to one aspect of the present invention, there is provided a solvent composition for extracting carbon dioxide from a gaseous mixture, the solvent comprising:
a first component selected from the group consisting of: diethylaminoethanol; 1-(2-hydroxhyl) pyrrolidine; 3-diethylamino-1,2-propanediol; 3-diethylamino-1-propanol; 1-diethylamino-2-propanol and combinations thereof; and a second component selected from the group consisting of: hexamethylenediamine (HMDA); 4-amino-1-butanol and combinations thereof.

According to another aspect of the present invention, there is provided a solvent composition for extracting carbon dioxide from a gaseous mixture, the solvent comprising 1-(2-hydroxyethyl) pyrrolidine (PR), hexamethylenediamine (HMDA), and water.

According to yet another aspect of the present invention, there is provided a solvent composition for extracting carbon dioxide from a gaseous mixture, the solvent comprising PR, HMDA, and polyethylenimine (PEI).

According to a preferred embodiment of the present invention, PR is present in molar concentration ranging from 2.0M to 4.0M.

According to a preferred embodiment of the present invention, HMDA is present in molar concentration ranging from 0.1M to 1.5M.

According to a preferred embodiment of the present invention, PEI is present in molar concentration ranging from 0.001M to 0.5M.

According to a preferred embodiment of the present invention, the total molar concentration of the solvent composition is in the range of 2.10M to 6.9M.

According to a preferred embodiment of the present invention, the solvent consists essentially of 1-(2-hydroxyethyl) pyrrolidine (PR), hexamethylenediamine (HMDA), polyethylenimine (PEI), and water.

Most preferably, in the present invention, PR is present in molar concentration of 3.6M, HMDA is present in molar concentration of 1.0M, and PEI is present in molar concentration of 0.01M.

According to a preferred embodiment of the present invention, the solvent has a heat duty below 160 kJ/mol CO₂.

More preferably, in the present invention, the solvent composition has a heat duty below 120.0 kJ/mol CO₂.

According to a preferred embodiment of the present invention, the solvent has an initial absorption rate greater than

$$0.25 \frac{{10}^{- 2} * kJ mol {CO}_{2}}{L \cdot soltn * min} .$$

More preferably, in the present invention, the solvent composition has an initial absorption rate greater than

$$0.4 \frac{{10}^{- 2} * kJ mol {CO}_{2}}{L \cdot soltn * min} .$$

According to a preferred embodiment of the present invention, the solvent composition has an initial desorption rate greater than

$$18. \frac{{10}^{- 2} * kJ mol {CO}_{2}}{L \cdot soltn * min} .$$

More preferably, in the present invention, the solvent composition has an initial desorption rate greater than

$$35. \frac{{10}^{- 2} * kJ mol {CO}_{2}}{L \cdot soltn * min} .$$

According to a preferred embodiment of the present invention, the solvent composition has a cyclic capacity greater than

$$0.95 \frac{mol {CO}_{2}}{L \cdot soltn} .$$

More preferably, in the present invention, the solvent composition has a cyclic capacity is greater than

$$1.05 \frac{mol {CO}_{2}}{L \cdot soltn} .$$

According to a preferred embodiment of the present invention, the solvent composition has a lean loading of 0 at 110° C.

According to a preferred embodiment of the present invention, the solvent composition has a viscosity below 10 mPa·s at 30° C.

According to a preferred embodiment of the present invention, the solvent composition has an alkalinity in the range of 9.5 to 11.0 pKa at room temperature.

According to one aspect of the present invention, there is provided a solvent composition for extracting carbon dioxide from a gaseous mixture, the solvent composition comprising PR, HMDA, and a PEI, wherein PR is present in molar concentration ranging from 3.0M to 5.0M and HMDA is present in molar concentration ranging from 0.1M to 1.5M.

According to a preferred embodiment of the present invention, PR is present in molar concentration ranging from 3.3M to 3.9M, HMDA is present in molar concentration ranging from 0.5M to 1.2M, and PEI is present in molar concentration ranging from 0.005M to 0.015M.

Most preferably, in the present invention, PEI is present in molar concentration of 0.01M.

According to one aspect of the present invention, there is provided a method of performing carbon capture comprising collecting a flue gas comprising carbon dioxide from a flue gas emitting source and exposing the collected flue gas to a solvent composition according to a preferred embodiment of the present invention for a period of time sufficient to remove at least a portion of said carbon dioxide gas present in said flue gas.

According to another aspect of the present invention, there is provided an apparatus for performing carbon capture comprising components configured to perform a method of performing carbon capture comprising: collecting a flue gas, comprising carbon dioxide from a flue gas emitting source; and exposing the collected flue gas to a solvent composition according to a preferred embodiment of the present invention for a period of time sufficient to remove at least a portion of said carbon dioxide gas present in said flue gas.

According to yet another aspect of the present invention, there is provided a system for performing carbon capture comprising components configured to perform a method of performing carbon capture comprising: collecting a flue gas, comprising carbon dioxide from a flue gas emitting source; and exposing the collected flue gas to a solvent composition according to a preferred embodiment of the present invention for a period of time sufficient to remove at least a portion of said carbon dioxide gas present in said flue gas.

According to one aspect of the present invention, there is provided the use of a solvent composition according to a preferred embodiment of the present invention to perform carbon capture.

According to another aspect of the present invention, there is provided a solvent composition for extracting carbon dioxide from a gaseous mixture, the solvent composition comprising:
(i) a molar concentration in the range of 2.0M to 5.0M of compound I which is a tertiary amine;
(ii) a molar concentration in the range of 0.1M to 1.5M of compound II which comprises two primary amino groups, having a chemical formula of NH₂—(CₘH₂ₘ)—NH₂, where m is an integer between 2 to 10;
(iii) a molar concentration in the range of 0.001M to 0.5M of a polyethyleneimine (PEI); and
(iv) water.

According to a preferred embodiment of the present invention, compound II comprises two primary amino groups, having a chemical formula of NH₂—(CₘH₂ₘ)—NH₂, where m is an integer between 4 to 8.

According to another aspect of the present invention, there is provided a solvent composition that may be used for extracting carbon dioxide from a gaseous mixture. According to a preferred embodiment of the present invention, the solvent composition comprises one or more of 1-(2-hydroxyethyl) pyrrolidine (PR), hexamethylenediamine (HMDA), polyethylenimine (PEI), and water.

In some preferred embodiments, the molar concentration of the PR is in the range of 2.0M to 5.0M. In some preferred embodiments, the molar concentration of the HMDA is in the range of 0.1M to 1.5M. In some preferred embodiments, the molar concentration of the PEI is in the range of 0.001M to 0.5M. In some preferred embodiments, the total molar concentration of the solvent composition is in the range of 2.10M to 6.9M. As the person skilled in the art will understand, the total molar concentration of the solvent composition refers to the concentration of the compounds which form the solvent composition while excluding water.

In some preferred embodiments, the solvent composition consists essentially of 1-(2-hydroxyethyl) pyrrolidine (PR), hexamethylenediamine (HMDA), a polyethylenimine (PEI), and water. In some preferred embodiments, the molar concentration of the PR is 3.6M, the molar concentration of the HMDA is 1.0M, and the molar concentration of the PEI is 0.01M. In some preferred embodiments, the PR has the CAS Registry Number #2955-88-6.

According to a preferred embodiment of the present invention, the PEI is a branched PEI. According to a preferred embodiment of the present invention, the molar mass of the PEI ranges from 400 g/mol to 1200 g/mol. Preferably, the molar mass of the PEI ranges from 600 g/mol to 1000 g/mol. In some preferred embodiments, the molar mass for the PEI is approximately 800 g/mol. In some preferred embodiments, the PEI has the CAS Registry Number CAS #25987-06-8.

In some preferred embodiments, the solvent composition has a viscosity below 10 mPa·s at 30° C. In some preferred embodiments, the solvent composition has an alkalinity in the range of 9.5 to 11.0 pKa at room temperature.

Advantageously, some preferred embodiments of the solvent composition may have a heat duty that is about 3.85 times lower than that of MEA. For example, some preferred embodiments of the solvent composition may have a heat duty below about 120 kJ/mol CO₂. This can provide a major reduction in energy input costs and operating costs for carbon capture methods, systems and/or apparatuses that use the solvent composition.

Advantageously, some preferred embodiments of the solvent composition may have an initial absorption rate that is greater than about

$$0.25 \frac{{10}^{- 2} * kJ mol {CO}_{2}}{L \cdot soltn * min} .$$

This can reduce the size and/or cost of carbon capture systems and/or apparatuses that use the solvent composition.

Advantageously, some preferred embodiments of the solvent composition may have an initial desorption rate that is about 3.85 times higher than that of MEA. For example, some preferred embodiments of the solvent composition may have an initial desorption rate that is greater than about

$$25. \frac{{10}^{- 2} * kJ mol {CO}_{2}}{L \cdot soltn * min} .$$

This can reduce the size and/or cost of carbon capture systems and/or apparatuses that use the solvent composition.

Advantageously, some preferred embodiments of the solvent composition may have a cyclic capacity that is 85% higher than that of MEA. For example, some preferred embodiments of the solvent composition may have a cyclic capacity greater than 1.15 (e.g., greater than about

$$1.2 ) \frac{mol {CO}_{2}}{L \cdot soltn} .$$

This can reduce the volume of the solvent composition required in carbon capture processes and reduce the size and/or cost of carbon capture systems and/or apparatuses that use the solvent composition.

Advantageously, some preferred embodiments of the solvent composition may have a lean loading of approximately 0 at 110° C. This can help achieve nearly complete release of captured CO₂ at lower relative temperatures, which is expected to further reduce energy requirements systems and/or apparatuses that use the solvent composition.

According to a preferred embodiment of the present invention, the solvent composition may have at least one of the following properties: a heat duty below 120 kJ/mol CO₂, an initial absorption rate greater than

$$0.25 \frac{{10}^{- 2} * kJ mol {CO}_{2}}{L \cdot soltn * min} ,$$

an initial desorption rate greater than

$$25. \frac{{10}^{- 2} * kJ mol {CO}_{2}}{L \cdot soltn * min} ,$$

a cyclic capacity greater than

$$0.95 \frac{mol {CO}_{2}}{L \cdot soltn} ,$$

a lean loading of 0 at 110° C., a viscosity below 10 mPa·s at 30° C., and an alkalinity in the range of 9.5 to 11.0 pKa at room temperature.

According to a preferred embodiment of the present invention, the solvent composition may have at least one of the following properties: a heat duty below 120 kJ/mol CO₂, an initial absorption rate greater than

$$0.25 \frac{{10}^{- 2} * kJ mol {CO}_{2}}{L \cdot soltn * min} ,$$

an initial desorption rate greater than

$$25 \frac{{10}^{- 2} * kJ mol {CO}_{2}}{L \cdot soltn * min} ,$$

a cyclic capacity greater than

$$1.2 \frac{mol {CO}_{2}}{L \cdot soltn} ,$$

a lean loading of 0 at 110° C., a viscosity below 10 mPa·s at 30° C., and an alkalinity in the range of 9.5 to 11.0 pKa at room temperature.

Another aspect of the present invention relates to a method of performing carbon capture. The method comprises collecting flue gas from a flue gas emitting source and reacting the collected flue gas with the solvent composition described herein.

Other aspects of the present invention relate to systems for performing carbon capture. Preferably, such systems comprise components configured to perform methods of performing carbon capture using the solvent compositions described herein. Other aspects of the present invention relate to an apparatus for performing carbon capture. Preferably, such apparatus comprises components configured to perform methods of performing carbon capture using the solvent compositions described herein.

Another aspect of the present invention relates to the use of a solvent composition according to a preferred embodiment of the present invention, to perform carbon capture by collecting a flue gas comprising carbon dioxide from a flue gas emitting source and exposing the collected flue gas to said solvent composition for a period of time sufficient to remove at least a portion of said carbon dioxide gas present in said flue gas.

Additional aspects of the present invention will be apparent in view the description which follows.

### BRIEF DESCRIPTION OF THE DRAWINGS

Features and advantages of the embodiments of the present invention will become apparent from the following detailed description, taken in combination with the appended drawings in which:

FIG. 1 is a flowchart depicting a method of carbon capture according to a preferred embodiment of the present invention.

FIG. 2 illustrates an experimental set-up used to measure the absorption and desorption characteristics of various exemplary solvent compositions of the present invention.

FIG. 3A illustrates the absorption profile of a 5M MEA solvent composition produced by an experiment performed using the FIG. 2 experimental set-up.

FIG. 3B illustrates the desorption profile of a 5M MEA solvent composition produced by an experiment performed using the FIG. 2 experimental set-up.

FIG. 4 shows the experimentally measured absorption performance of a baseline MEA solvent composition and various exemplary solvent compositions of the present invention produced by an experiment performed using the FIG. 2 experimental set-up.

FIG. 5 is a plot of the CO₂ loading profiles, by mol, of various exemplary solvent compositions of the present invention produced by an experiment performed using the FIG. 2 experimental set-up.

FIG. 6 shows the experimentally measured CO₂ loading, by mol, of various exemplary solvent compositions of the present invention produced by an experiment performed using the FIG. 2 experimental set-up.

FIG. 7 is a plot of the CO₂ desorption profiles, by mol, of various exemplary solvent compositions of the present invention produced by an experiment performed using the FIG. 2 experimental set-up.

FIG. 8 shows the experimentally measured desorption performance of a baseline MEA solvent composition and various exemplary solvent compositions of the present invention produced by an experiment performed using the FIG. 2 experimental set-up.

FIG. 9 shows the experimentally measured heat duty of various exemplary solvent compositions of the present invention produced by an experiment performed using the FIG. 2 experimental set-up.

FIG. 10 shows the experimentally measured CO₂ loading of various exemplary solvent compositions of the present invention produced by an experiment performed using the FIG. 2 experimental set-up.

FIG. 11 shows the experimentally measured cyclic capacity of various exemplary solvent compositions of the present invention produced by an experiment performed using the FIG. 2 experimental set-up.

FIG. 12 shows the experimentally measured absorption/desorption parameter of various exemplary solvent compositions of the present invention produced by an experiment performed using the FIG. 2 experimental set-up.

FIG. 13 illustrates an experimental set-up used to measure the degradation and NH3 emission characteristics of various exemplary solvent compositions of the present invention.

FIG. 14 a), b), c), d), e) and f) shows the degradation profile of 5M MEA, 3.6M D, 3.6M PR, Component D in EN23, and Component PR in EN23A1 produced by an experiment performed using the FIG. 13 experimental set-up; and

FIG. 15 shows the NH3 emission profiles of various exemplary solvent compositions of the present invention produced by an experiment performed using the FIG. 13 experimental set-up.

### DETAILED DESCRIPTION

The description which follows and the embodiments described therein are provided by way of illustration of an example or examples of particular embodiments of the principles of the present invention. In the following description of the invention, numerous examples are provided and specific details are set forth for the purposes of explanation and not limitation in order to provide a thorough understanding of the invention. The person skilled in the art will readily appreciate that the well-known methods, procedures and/or components will not be described as to focus on the invention in question. Accordingly, in some instances, certain structures and techniques have not been described or shown in detail in order not to obscure the invention.

It was determined that the performance of amines (e.g. their volatility, tolerance to amine degradation and the consequent emissions) in carbon capture processes can depend highly on the amine's functional groups and how they are placed in the amine structure. The chemical structural positioning of different functional groups in different amines and their effects on the rates of CO₂ absorption and desorption, CO₂ cyclic capacity, heat duty, volatility, amine degradation, off-gas emissions (specifically NH₃), corrosion, and foaming were recorded and assessed. It was noted that the interaction of components in a given solvent composition can influence the overall performance of the solvent composition. Careful selection of various components of a given carbon capture solvent composition based on their possible interactions was undertaken to develop novel solvent composition systems which outperform known solvent compositions used in carbon capture.

In light of the above knowledge and as described in more detail elsewhere herein, the inventors have formulated and reduced to practice solvent composition compositions that substantially outperform conventional solvent compositions (e.g. 5M MEA) used in carbon capture applications. Unless context dictates otherwise, such solvent composition compositions may be referred to herein as solvent compositions. The term solvent, as used herein, can be interchangeably referred to as a composition and may be a compound or a blend or mixture of a plurality of compounds (i.e., a “solvent blend” or a “solvent mixture”). Carbon capture solvent compositions as described herein typically comprise a first compound, which may be referred to herein as “Compound I”, and/or a second compound, which may be referred to herein as “Compound II”. The person skilled in the art will also understand that solvent composition is meant to refer to a liquid, more preferably a homogeneous liquid.

According to a preferred embodiment of the present invention, compound I is a tertiary amine, having a chemical formula of (R₁)(R₂)N(CₙH₂ₙ—OH), where R1 and R2 together form a ring with a carbon number between 3 to 6, preferably between 3 to 5, more preferably where there are 4 carbons, and n is an integer between 1 to 6, preferably between 2 to 4, more preferably n is 2. According to a preferred embodiment of the present invention, compound I is 1-(2-hydroxyethyl) pyrrolidine.

As used herein, the term “1-(2-hydroxyethyl) pyrrolidine” or “PR” refers to a tertiary amine. The richness of electrons on the amino group reaction center can enhance the CO₂ and amine reactivity. Thus, additional electrons supplied to the PR's amino nitrogen increases its reaction absorption rate with CO₂.

Advantageously, PR also has a fast CO₂ desorption rate. Since PR is a tertiary amine, bicarbonate (HCO₃⁻) and carbonate (CO₃²⁻) are only formed from the absorption reaction. Due to the negative charges on the two anionic products, they are also attracted to the protonated amine generated also in the solution. Such attraction determines the desorption ability of the amine such that the weaker the electrostatic attraction between the charged species, the better and the faster the desorption rate.

According to a preferred embodiment of the present invention, compound II contains two primary amino groups, having a chemical formula of NH₂—(CₘH₂ₘ)—NH₂, where m is an integer between 2 to 10, preferably between 4 to 8. According to a preferred embodiment of the present invention, compound II can be, for example, hexamethylenediamine.

As used herein, the term “hexamethylenediamine” or “HMDA” refers to a diamine whose molecule comprises two (2) primary amino groups connected to each other by six (6) carbons. The primary amino groups in HMDA structure are able to provide a maximum of two (2) active sites for the CO₂ absorption reaction to take place. This also implies that one (1) molecule of HMDA can take a maximum of two (2) molecules of CO₂. In comparison to conventional primary amines such as MEA, the CO₂ access to a reaction reactive site on the MEA molecule is limited to one (1), thus the absorption reaction occurs only on the basis of one (1) molecule of MEA per one (1) molecule of CO₂. Hence, HMDA helps to increase the CO₂ amount absorbed per cycle as compared to that obtained from MEA.

According to a preferred embodiment of the present invention, carbon capture solvent compositions described herein may also comprise one or more additional compounds in addition to Compound I and/or Compound II described above. For example, carbon capture solvent compositions described herein may comprise polyethylenimine.

As used herein, the term “polyethylenimine” or “PEI” refers to a polymeric amine whose structure contains: (a) multiple groups of primary, secondary, and tertiary amine encased in a branched polymeric structure; (b) multiple groups of primary and tertiary amine encased in a branched polymeric structure; or (c) multiple groups of secondary amine in a linear polymeric structure. Branched polyethylenimines with all of primary, secondary, tertiary amino groups are preferred in some embodiments of the present invention. The absorption capacity of PEI benefits from its primary and secondary amino groups while secondary and tertiary amino groups facilitate its desorption of CO₂. According to a preferred embodiment of the present invention, the PEI has up to fifteen (15) active amino groups that have affinity toward CO₂ in the absorption reaction. This implies that the CO₂ amount captured per amine molecule of PEI can far exceed those of conventional amines like MEA and MDEA, whose CO₂ capacities are known to be limited to 0.5 and 1 respectively. Thus, the CO₂ capture capacity of PEI can be several-fold more than those of the single amines.

According to a preferred embodiment of the present invention, the carbon capture solvent composition comprises one or more of: 1-(2-hydroxyethyl) pyrrolidine (PR), hexamethylenediamine (HMDA), and polyethylenimine (PEI). For example, the carbon capture solvent blend may be an aqueous solution comprising one or more of: 1-(2-hydroxyethyl) pyrrolidine (PR), hexamethylenediamine (HMDA), and polyethylenimine (PEI).

In some embodiments, the solvent composition comprises PR with a molar concentration in the range of 2.0M to 5.0M (e.g., 2.0M, 2.05M, 2.10M, 2.15M, 2.20M, 2.25M, 2.30M, 2.35M, 2.40M, 2.45M, 2.50M, 2.55M, 2.60M, 2.65M, 2.70M, 2.75M, 2.80M, 2.85M, 2.90M, 2.95M, 3.00M, 3.05M, 3.10M, 3.15M, 3.20M, 3.25M, 3.30M, 3.35M, 3.40M, 3.45M, 3.50M, 3.55M, 3.60M, 3.65M, 3.70M, 3.75M, 3.80M, 3.85M, 3.90M, 3.95M, 4.00M, 4.05M, 4.10M, 4.15M, 4.20M, 4.25M, 4.30M, 4.35M, 4.40M, 4.45M, 4.50M, 4.55M, 4.60M, 4.65M, 4.70M, 4.75M, 4.80M, 4.85M, 4.90M, 4.95M, 5.00M, or any value therebetween).

In some embodiments, the solvent composition comprises HMDA with a molar concentration in the range of 0.10M to 1.50M (e.g., 0.10M, 0.15M, 0.20M, 0.25M, 0.30M, 0.35M, 0.40M, 0.45M, 0.50M, 0.55M, 0.60M, 0.65M, 0.70M, 0.75M, 0.80M, 0.85M, 0.90M, 0.95M, 1.00M, 1.05M, 1.10M, 1.15M, 1.20M, 1.25M, 1.30M, 1.35M, 1.40M, 1.45M, 1.50M, or any value therebetween).

In some embodiments, the solvent composition comprises PEI with a molar concentration in the range of 0.005M to 0.50M (e.g., 0.005M, 0.01M, 0.015M, 0.02M, 0.025M, 0.03M, 0.035M, 0.04M, 0.045M, 0.05M, 0.10M, 0.15M, 0.20M, 0.25M, 0.30M, 0.35M, 0.40M, 0.45M, 0.50M, or any value therebetween).

In some embodiments, the solvent composition comprises PEI having a molecular weight of between about 750 Da to about 850 Da (e.g., 800 Da). In some embodiments, the number of repeating units of the PEI in the solvent composition is about 1.5. In some cases, if the PEI's molar mass it too high, it may cause the solvent composition to be too viscous and suboptimal for carbon capture applications in some cases.

In some embodiments, the solvent composition has a total molar concentration of 6.9M or less (i.e., beyond which precipitation issues and phase separation issues may occur). In some embodiments, the solvent composition has a total molar concentration of about 6.0M (e.g., within ±0.01M), preferably of about 5.5M (e.g., within ±0.01M), more preferably of about 5.0M (e.g., within ±0.01M), even more preferably of about 4.5M (e.g., within ±0.01M) and yet even more preferably, 4.0M (e.g., within ±0.01M). In some embodiments, the solvent composition comprises 3.6M PR, 1.0M HMDA, and 0.01M PEI (e.g., within ±0.001M for each of PR, HMDA, and PEI).

In some embodiments, the solvent composition has a lean loading of ˜0 at 110° C. (i.e., implying that the solvent composition can be used at relatively lower temperatures while achieving lean loadings close to 0).

In some embodiments, the solvent composition has a viscosity below 10 m·Pas at 30° C. (e.g., 9.5 mPa·s, 9.0 mPa·s, 8.5 mPa·s, 8.0 mPa·s, 7.5 mPa·s, 7.0 mPa·s, 6.5 m·Pas, 6.0 mPa·s, 5.5 mPa·s, 5.0 mPa·s, 4.5 mPa·s, 4.0 m·Pas, 3.5 mPa·s, 3.0 mPa·s, 2.5 mPa·s, 2.0 mPa·s, 1.5 mPa·s, 1.0 m·Pas, or any value therebetween at 30° C.).

In some embodiments, the solvent composition has an alkalinity in the range of 9.5 to 11.0 pKa at room temperature (e.g., 9.55 pKa, 9.60 pKa, 9.65 pKa, 9.70 pKa, 9.75 pKa, 9.80 pKa, 9.85 pKa, 9.90 pKa, 9.95 pKa, 10.00 pKa, 10.05 pKa, 10.10 pKa, 10.15 pKa, 10.20 pKa, 10.25 pKa, 10.30 pKa, 10.35 pKa, 10.40 pKa, 10.45 pKa, 10.50 pKa, 10.55 pKa, 10.60 pKa, 10.65 pKa, 10.70 pKa, 10.75 pKa, 10.80 pKa, 10.85 pKa, 10.90 pKa, 10.95 pKa, or any value therebetween at room temperature).

It was noted that functional groups that increase the electron density around the nitrogen reactive site can increase the CO₂ absorption rate. In some instances, amines with multi amine groups were also recognized to increase CO₂ absorption rate due to increased number of available nitrogen reactive sites. In addition, it was noted that the high number of amino groups increased the CO₂ absorption capacity of the amines. Based on this knowledge, it was assessed that including a diamine such as HMDA in a solvent blend can provide the benefits of fast CO₂ absorption kinetics.

It was surprisingly and unexpectedly discovered that PEI, a multi amine polymer, when included in a solvent blend, substantially improved solvent qualities for use in carbon capture and sequestration. According to a preferred embodiment of the present invention, a branched PEI with about fifteen (15) amine groups increased the CO₂ absorption kinetics and the CO₂ carrying capacity of the solvent blend. PEI is a very viscous amine and can be preferably used at concentrations at and below about 0.3M.

According to a preferred embodiment of the present invention and in order to tackle the desorption aspect of the solvent blend, a component with a high performing desorption ability was incorporated into the solvent composition. It was recognized that tertiary amines, which are typically known to have high desorption performance, have low absorption performance due to the absence of a hydrogen atom on the central nitrogen atom. In view of this, a tertiary amine whose structure can allow it to absorb CO₂ faster than a traditional tertiary amine would was incorporated into the solvent composition.

According to a preferred embodiment of the present invention, a solvent composition described herein provides improved performance over conventional solvent compositions used in carbon capture processes. For example, some solvent blends described herein provide an initial CO₂ absorption rate that is up to about 14% higher than that of convention MEA solvents (e.g., Solvent EN 23A-1 described below had a higher initial CO₂ absorption rate than 5M MEA). As another example, some solvent blends described herein provide an initial CO₂ desorption rate that is up to about 3.85 times higher than that of conventional MEA solvents. As another example, some solvent blends described herein provide cyclic capacity that is up to about 85% higher than that of conventional MEA solvents. As another example, some solvent blends described herein have much lower NH₃ emission rates than those of conventional MEA solvents.

Other additional non-limiting advantages provided by preferred compositions described herein are described in more detail below with reference to certain specific properties of other known compositions:
In comparison with HMDA-PZ solvent compositions, where HMDA helps to solve the solubility issue encountered in that mixture thereby widening the molality for PZ to absorb more CO₂, solvent compositions described herein use HMDA as an accelerant, thereby increasing the absorption rate;
In comparison with other solvent composition formulas that require the absorbing process to be provided at 1 bar or higher and/or the desorbing process to be provided at 0.01 bar and higher (i.e., other solvent composition formulas can require a pressurized CO₂ capture system), solvent compositions described herein can be used in both atmospheric and pressurized CO₂ absorption systems;

While HMDA has been proposed for use in applications related to carbon capture, existing technologies are limited to using HMDA in association with solid sorbents, using HMDA in a biphasic scrubbing solution, and using HMDA as a cluster stabilizer.

While PEI has been proposed for use in applications related to carbon capture, existing technologies are limited to using PEI in amine solid sorbent for CO₂ adsorption (e.g., using PEI as part of the carbon capture layer where the amine is functionalized on to solid materials such as graphene oxide or non-porous carbon).

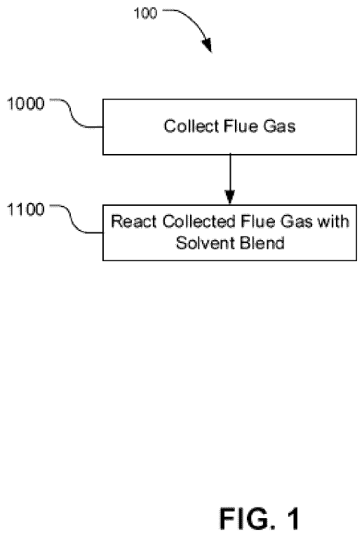

Another aspect of the invention provides a method of carbon capture using solvent compositions described herein. FIG. 1 is a flowchart depicting a method 100 of performing carbon capture according to a preferred embodiment. Method 100 begins at step 1000, where flue gas is collected from one or more CO₂ sources (e.g., an industrial facility, a plant, a machine, an engine, etc.). The flue gas may be collected using any suitable method in step 1000. After collecting the flue gas in step 1000, method 100 proceeds to step 1100. At step 1100, a solvent composition is reacted with the collected flue gas to separate CO₂ from the rest of the flue gas. The solvent composition is understood to be any one of the preferred solvent compositions according to the present invention. In some embodiments, step 1100 comprises reacting the collected flue gas with a solvent blend comprising one or more of: 1-(2-hydroxyethyl) pyrrolidine (PR), hexamethylenediamine (HMDA), and polyethylenimine (PEI). In some embodiments, step 1100 comprises reacting the collected flue gas with a solvent blend comprising 1-(2-hydroxyethyl) pyrrolidine (PR), hexamethylenediamine (HMDA), and polyethylenimine (PEI). In some embodiments, step 1100 comprises reacting the collected flue gas with an aqueous solution comprising 1-(2-hydroxyethyl) pyrrolidine (PR), hexamethylenediamine (HMDA), and polyethylenimine (PEI). Step 1100 may comprise reacting the collected flue gas with a solvent composition comprising 1-(2-hydroxyethyl) pyrrolidine (PR), hexamethylenediamine (HMDA) and/or polyethylenimine (PEI), where each compound may have any suitable concentration (e.g., any concentration described herein).

After reacting the collected flue gas with the solvent composition in step 1100, method 100 may, in some embodiments, proceed to one or more of the following optional steps (not shown): a step of regenerating the solvent blend by stripping away the captured CO₂ from the rich solvent composition, a step of releasing the clean flue gas into the atmosphere, a step of injecting the stripped CO₂ into a geological formation, etc.

Other aspects of the invention include systems and/or apparatuses that may be configured to implement carbon capture methods of the kind described above.

In addition to the exemplary aspects described above, the present invention is further described in the following Examples, which are set forth to aid in the understanding of the invention, and should not be construed to limit in any way the scope of the invention as defined in the claims which follow thereafter.

### EXAMPLES

The viability of different combinations of solvents for use in carbon capture processes was assessed. In the experiments, various aqueous amine solutions were prepared to a desired condition by mixing predetermined mass of the amine/amines with deonized water. The amine/amines comprised one or more of the following compounds: 2-1-(2-hydroxyethyl) pyrrolidine (PR), hexamethylenediamine (HMDA), polyethylenimine (PEI, branch), 2-diethylaminoethanol (DEAE), 4-Amino-1-butanol (E), 3-diethylamino-1,2-propanediol (F), 3-diethylamino-1-propanol (3D), and monoethanolamine (MEA).

In the experiments, 1M hydrochloric acid (HCl, Fisher Chemical) was used for titration with methyl orange as an indicator to confirm the concentration of the amine solution and the solution's CO₂ loading. In the experiments, Sulfuric acid (H₂SO₄, >67%, Fisher Chemical) was used to prepare the impinger solution for collection of NH₃ in off-gas released from the amine degradation reaction. Research grade of 100% CO₂, 100% O₂, air, and 100% N₂ were all industrial grade and supplied from Linde (Regina, Saskatchewan, Canada). The desired feed gas concentration used in the experiments was obtained by the inventors by mixing predetermined volumetric flow rates of individual gases needed for such experiment which were adjusted and controlled by mass flow meters (Cole-Parmer, Canada). Final concentrations of all constituents in the mixed gas stream were confirmed by the inventors using infrared based multi-gas analyser (Nova Analytical Systems, Canada).

The compositions of the solvents used in the experiments are shown in Table 1 below:

TABLE 1
Shows the composition of the solvents used by the inventors to perform experiments

| | PR | HMDA | PEI | DEAE | E | F | 3D | MEA | Total |
|---|---|---|---|---|---|---|---|---|---|
| Baseline | | | | | | | | 5.00M | 5.00M |
| MEA | | | | | | | | | |
| EN 23 | | 0.4M | 0.01M | 3.60M | | | | | 4.01M |
| EN 23A | 3.60M | 0.4M | 0.01M | | | | | | 4.01M |
| EN 23B | 3.60M | | 0.01M | | 0.4M | | | | 4.01M |
| EN 23A-1 | 3.60M | 1.0M | 0.01M | | | | | | 4.61M |
| EN 23A-2 | 4.00M | 0.4M | 0.01M | | | | | | 4.41M |
| EN 23A-3 | 4.00M | 1.0M | 0.01M | | | | | | 5.01M |
| EN 23A-4 | 3.60M | 1.2M | 0.01M | | | | | | 4.81M |
| EN 23B-1 | | 1.0M | 0.01M | | | 3.60M | | | 4.61M |
| EN 23B-2 | | 0.40M | 0.01M | | | 3.60M | | | 4.01M |
| EN 23B-3 | | 0.60M | 0.01M | | | 3.60M | | | 4.21M |
| EN 23C-1 | | 1.0M | 0.01M | | | | 3.60M | | 4.61M |
| EN 23C-2 | | 0.40M | 0.01M | | | | 3.60M | | 4.01M |
| EN 23C-3 | | 0.60M | 0.01M | | | | 3.60M | | 4.21M |
| EN 23C-4 | | 0.80M | 0.01M | | | | 3.60M | | 4.41M |

### Example 1—Absorption Experiment

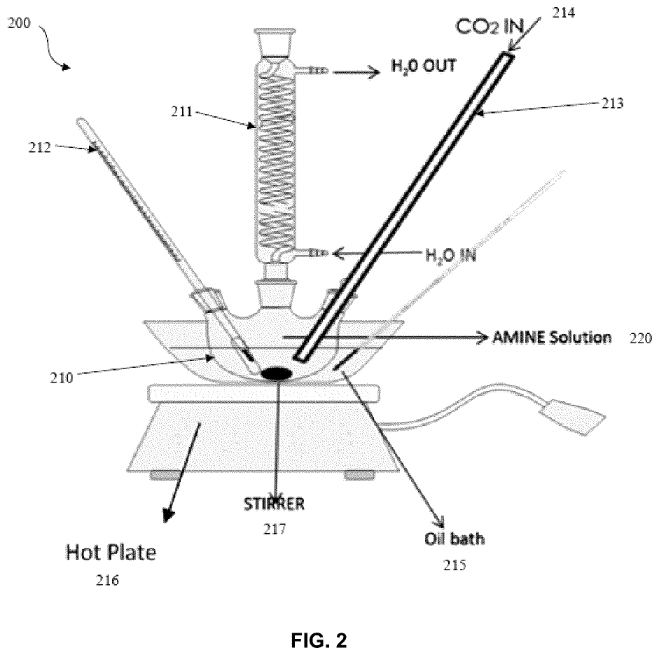

The CO₂ absorption rate of the solvent compositions was evaluated and listed in Table 1. The CO₂ absorption rate was evaluated by performing experiments using the apparatus 200 shown in FIG. 2. The apparatus 200 has a three-necked round bottomed flask 210 with a condenser 211 installed at the middle neck, a thermometer 212 at one neck for amine solution temperature measurement, and a gas dispersion tube 213 on the other neck for feeding the gas 214. The three-necked round bottomed flask 210 is immersed in an oil bath 215 and placed on top of, and heated by, a hot plate 216. A magnetic stirring bar 217 is placed inside the flask 210.

At the beginning of each absorption experiment, a prepared amine solution 220 of 150 ml contained in the flask 210 was fully immersed in the oil bath 215 in order for the amine solution 220 to reach the temperature of 40±° C. The gas 214 (4% CO₂ and 96% N₂) was then bubbled into the amine solution 220 through the gas dispersion tube 213 at a constant flow rate of 300 ml/min (±2 accuracy). Samples were then taken at regular intervals of 10 min for the first 1 hour, and then 30 min interval until at the end of 9 hours. The final loading recorded at the 9th hour was taken as the rich loading. Samples were analyzed using a Chittick apparatus to obtain the CO₂ loading at each time period, and a plot of CO₂ loading versus time was generated based on the data.

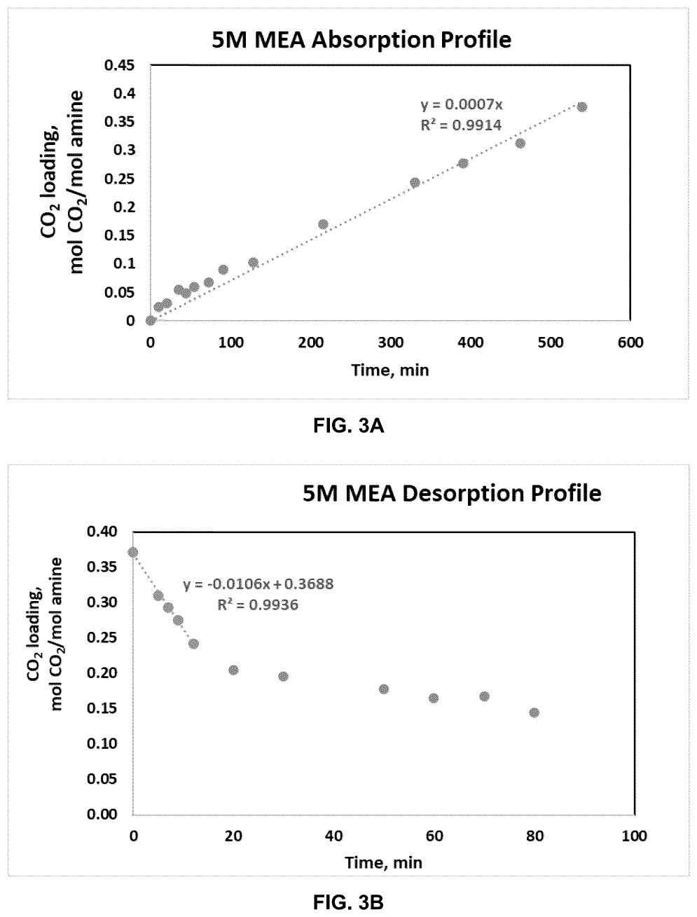

The slope of the linear section of the absorption profile was used to establish the initial absorption rate (mol CO₂/L·solution), which is essentially the slope multiplied by the total amine concentration. The initial absorption rate is calculated by multiplying the slope by the amine concentration. For example, the Absorption Profile of 5M MEA is shown in FIG. 3A and the initial absorption rate of such a solution is calculated as shown in Equation (1) below:

$$Initial Absorption Rate = 0.0007 \frac{mol CO 2}{mol amine \cdot min} * 5 \frac{mol amine}{litre of soltn} = 0.35 * {10}^{- 2} \frac{mol CO 2}{litre of soltn \cdot min} \qquad ( 1 )$$

### Linear Rate of Absorption

Given the linear nature of most of the absorption profiles, the rate of CO₂ absorption is measured by the Linear absorption rate and are summarized below.

From the absorption profile, the initial absorption rate was determined for each solvent composition and the results rank as follows; E 23>E 23A-1=E 23A-2>E 23A>E 23A-3=E 23B-3>E 23A-4=E 23C-2>MEA=E 23B2=E 23C-3>E 23B.

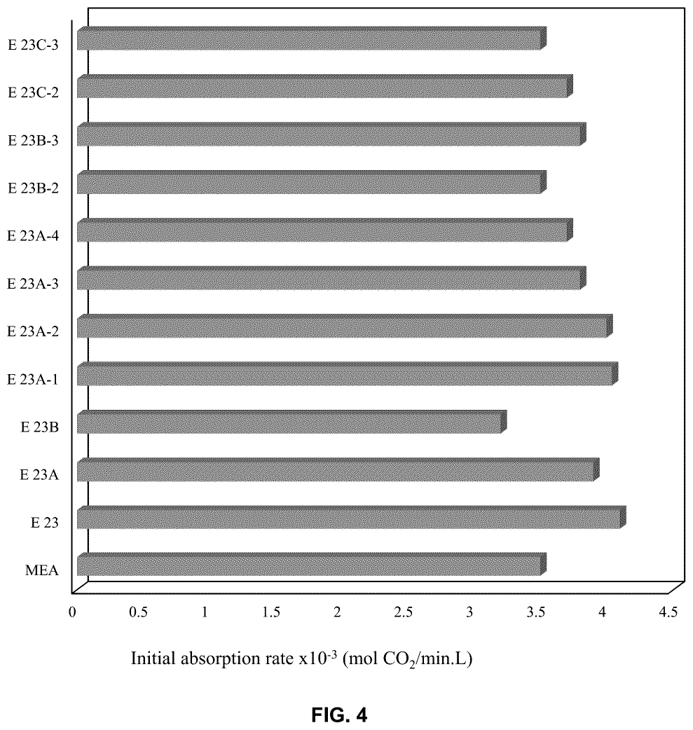

Reading from FIG. 4, E 23 recorded the highest rate of 4.1×10-3 mol CO₂/L·min while an equivalent rate of 4.0×10-3 mol CO₂/L·min was measured for E 23A-1. These values for E 23 and E 23A-1 are seen to be about 17% and 15% higher than the initial absorption rate obtained for benchmark MEA solvent, respectively. Similar to the trend observed in rich loading, E 23B recorded the minimum initial rate of CO₂ absorption. Other than that, significant rate values ranging from 3.5 to 3.9 (×10-3 mol CO₂/L·min) were obtained for the remaining solvent compositions. FIG. 4 details a summary of the initial absorption rates measured for all the solvent compositions.

### Rich Loading

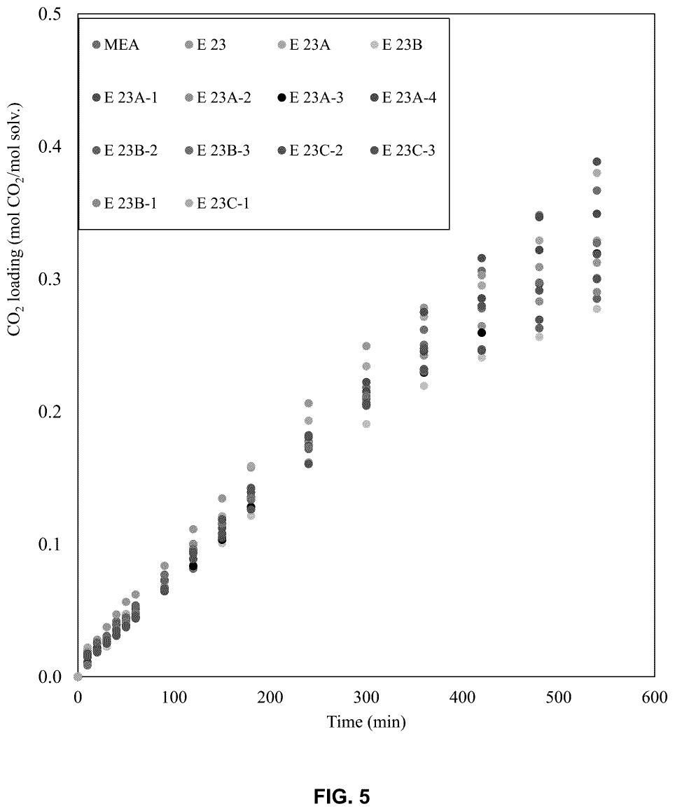

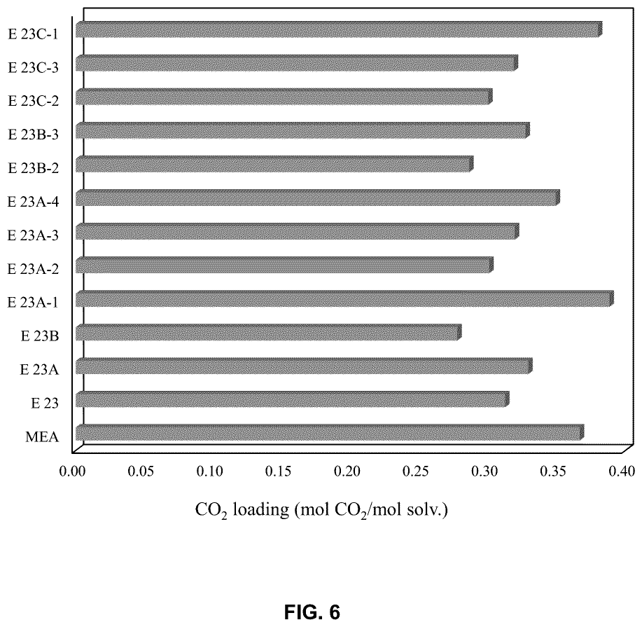

Rich loading indicates the amount of CO₂ that the amine solvent composition is able to hold at a given temperature. It is, therefore, used as a criterion to determine the maximum CO₂ absorption capacity of a solvent composition. From the absorption profiles in FIG. 5, the rich loadings for all the different solvent compositions after the 9 hours were determined and are summarized in FIG. 6 (on a mol basis). From the result illustrated in FIG. 6, in contrast to E 23, the measured rich loading for E 23A-1 (0.39 mol CO₂/mol solvent composition) was comparable and marginally higher than that of MEA (0.37 mol CO₂/mol solvent composition). It should be noted that solvent compositions including E 23C-1 and E 23B-1 precipitated either after or during the absorption process. The rich loading of E 23A-1 corresponds to a percentage enhancement of about 26% relative to the measured value obtained for E 23 solvent composition. The increase in concentration of H component from 0.4M to 1.0M accounted for this enhancement. However, at H concentrations above 1M, a decrease in loading resulting from a reduction in mass transfer owing to an increase in solvent composition viscosity was observed for E-23A-4.

Similar to the linear absorption rate, the lowest rich loading was measured for EN 23B. This is due to the absence of HMDA, a diamine not found in the EN 23B solvent composition. The varying concentration of HMDA in the different A-series solvent compositions accounts for the differences in rich loadings.

The CO₂ absorption rate and rich loading of the various different solvent compositions is listed in Table 2 below.

TABLE 2
CO₂ absorption rate for each solvent composition tested

| | Initial absorption rate of Carbon dioxide |
|---|---|
| Solvent composition | (mol CO₂/min · Lₛₒₗ) |
| Baseline (MEA) | 0.37 |
| EN 23 | 0.31 |
| EN 23A | 0.33 |
| EN 23B | 0.28 |
| EN 23A-1 | 0.39 |
| EN 23A-2 | 0.30 |
| EN 23A-3 | 0.32 |
| EN 23A-4 | 0.35 |
| E 23B-2 | 0.29 |
| E 23B-3 | 0.33 |
| E 23C-2 | 0.30 |
| E 23C-3 | 0.32 |

### Example 2—Desorption Experiment

The CO₂ desorption rate of the solvent compositions was also evaluated and listed in Table 1.

### Desorption Profile

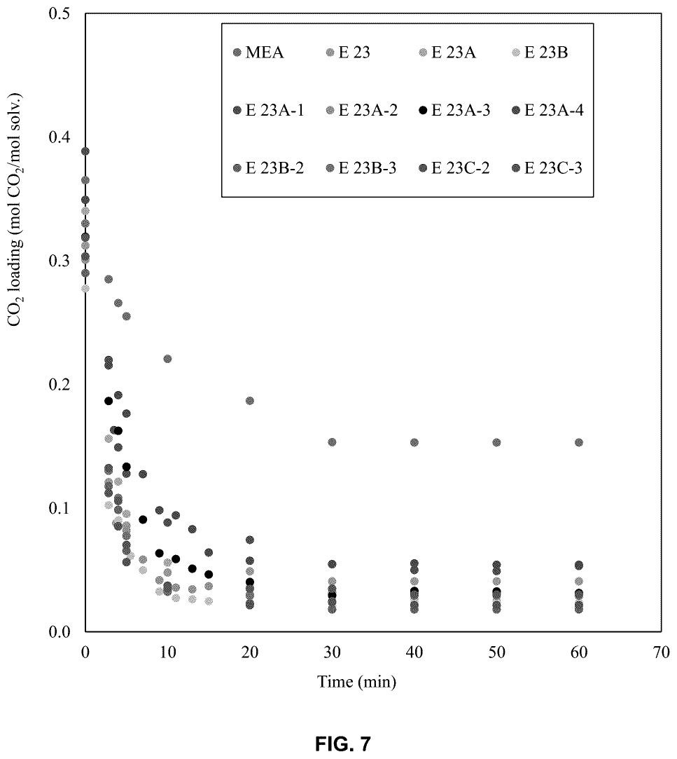

After every absorption run, the solvent compositions were kept for a minimum of 72 hours (3 days) to check for precipitation at room temperature. None of these solvent compositions precipitated within the said time. Afterwards, desorption was carried out for all the solvent compositions at 110±2° C. Samples were taken at different times and titrated against 1N HCl to develop the desorption profile. The desorption profiles for the various solvent compositions are shown in FIG. 7.

### Initial Desorption Rate

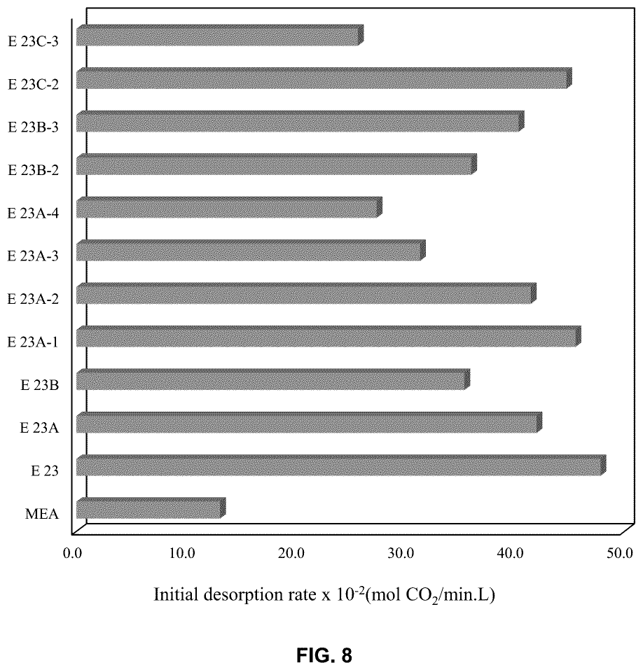

Like initial absorption rate analysis, each desorption profile was fitted with non-linear (logarithmic) regression model. Consequently, each model was differentiated at time zero (0) to evaluate the initial rate of desorption. Based on the obtained results as shown in FIG. 8, the solvent compositions ranked in increasing order of MEA<E 23C-3<E 23A-4<E 23A-3<E 23B<E 23B-2<E 23B-3<E 23A-2<E 23A<E 23C-2<E 23A-1<E 23.

The initial desorption rate was calculated by determining the slope of the linear section of the desorption as most of the removable CO₂ had been removed within that section. For example, the Desorption Profile of 5M MEA is shown in FIG. 3B and the initial desorption rate was calculated by multiplying the slope by the amine concentration shown in Equation (2) below:

$$Initial Desorption Rate = - 0.0106 \frac{mol {CO}_{2}}{mol amine \cdot min} * 5 \frac{mol amine}{litre of soltn \text{?} min} \qquad ( 2 )$$

$$\text{?} \text{indicates text missing or illegible when filed}$$

E 23 recorded the highest desorption rate of 48×10-2 mol CO₂/L·min. This was followed by E 23A-1 and E 23C-2 with values of 46 and 45 (×10-2 mol CO₂/L·min) respectively. Typical of primary amines, MEA recorded the least initial rate of desorption of 13×10-2 mol CO₂/Lmin. This is because, the main constituent in each formulated blend (being PR, F or 3D) is tertiary amine which results in the formation of extremely low energy bicarbonates from the absorption process. Considering this, minimum amount of energy is required for their stripping process which will occur at faster rates, hence, their relatively high desorption rate when compared with that of MEA.

The initial CO₂ desorption rate of the various different solvent compositions is shown in in FIG. 8 and listed in Table 3 below.

### Example 3—Heat Duty Determination

For each of the various solvent compositions listed in Table 1, the heat duty of the solvent composition based on the heat rate and the CO₂ desorption rate was determined. The heat duty was calculated by determining the ratio of the steady state heat transfer to the amount of CO₂ removed during desorption over a 5 min period (i.e., the linear portion of the desorption kinetics profile). Using Fourier's equation of molecular heat transport to calculate the heat supplied from the oil bath as shown in Equation (3):

$$Heat rate , q = \frac{kAdT}{dX} \qquad ( 3 )$$

where q is the rate of heat transfer at steady state in J/s, k is the thermal conductivity of the Pyrex glass used for the flask material in W/m K, A is the cross-sectional area normal to the direction of heat flow in m², and dT/dx is the temperature gradient (K⁻¹ m⁻¹). The temperature difference, dT was taken as the difference between the oil temperature and the inner wall temperature of the flask, while dx was the glass wall thickness. The heat duty was then calculated using Equation (4):

$$Heat Duty , \frac{heat rate , q ( \frac{J}{s} )}{{CO}_{2} removed \frac{mol}{\text{?}}} \qquad ( 4 )$$

$$\text{?} \text{indicates text missing or illegible when filed}$$

For example, the Heat Duty for baseline 5M MEA is calculated as follows:

$$Heat {Duty}_{MEA} = \frac{35.91 J / s}{5.3 \text{?} {10}^{- 2} \frac{mol {CO}_{2}}{L \cdot min} \text{?} 76 \text{?} {10}^{- 3} L \text{?} \frac{\text{?} min}{60 s}} = 534.91 kJ / mol CO 2$$

$$\text{?} \text{indicates text missing or illegible when filed}$$

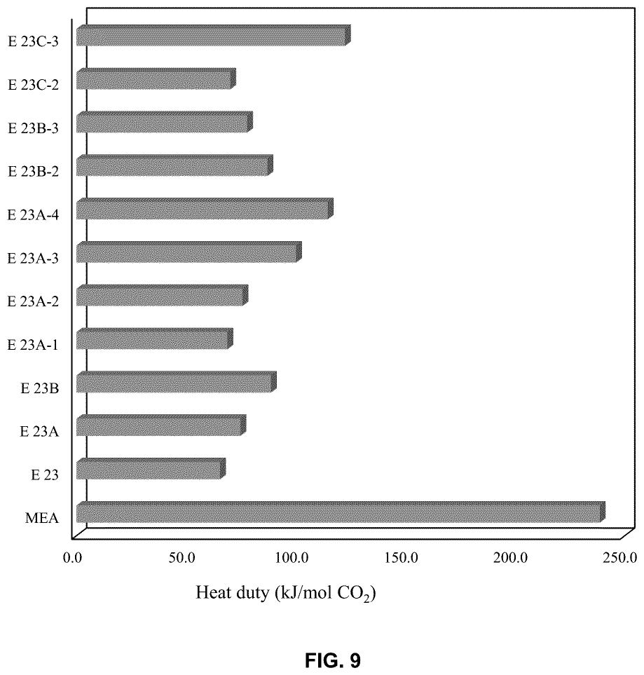

The heat duty of the various different solvent compositions is shown in in FIG. 9 and listed in Table 3 below. From FIG. 9, the heat duty is contrary to the trend observed in the initial CO₂ desorption rate data. It is believed that this is because, for a constant heat supply, as in the case for this work, the higher the initial rate of CO₂ desorption, the lower the solvent composition regeneration heat duty.

### Lean Loading

Lean loading is an indication of the efficiencies of the proposed solvent compositions' regeneration capacity and their ability to give off the CO₂ that was absorbed. It is the amount of CO₂ that is undesorbed from the solvent composition after the desorption process. Typically, a lower CO₂ lean loading is desired for an ideal CO₂ capture solvent composition since a relative higher CO₂ lean loading limits its ability to capture more CO₂ per cycle.

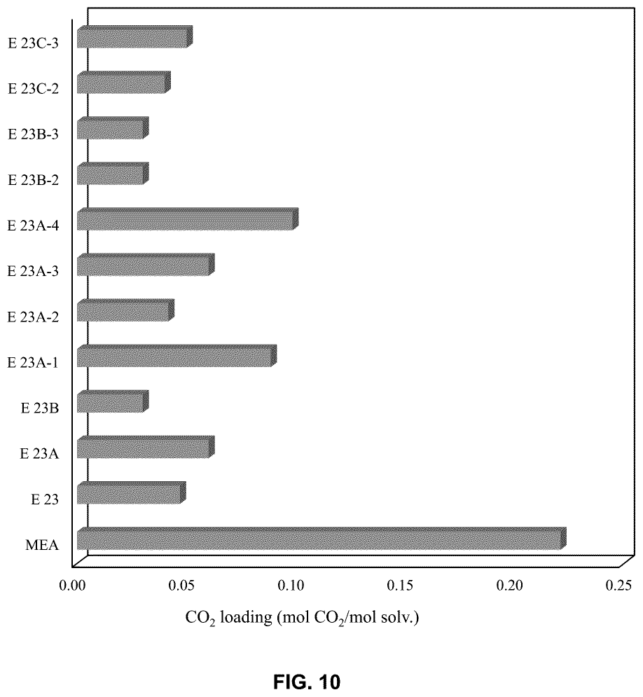

Comparing the proposed solvent compositions, solvent composition EN 23A-4 recorded the highest lean loading of 0.47 mol CO₂/Lₛₒₗᵥₑₙₜ while the minimum was measured for EN 23B. From the data in FIG. 10, the lean loading ranks in increasing order of EN 23B<EN 23A-2<EN 23<EN 23A<EN 23A-3<EN 23A-1<EN 23A-4<MEA.

Each of the proposed solvent compositions has a zero or almost zero lean loading characteristic. This observation is owed to the presence of tertiary amine as opposed to the primary constituent of each formulation. As seen in FIG. 10, relative to E 23, among the proposed solvent compositions, E 23A-1 and E 23A-4 recorded relatively high lean loading of about 0.1 mol CO₂/mol solvent composition. This can be explained in terms of the higher rich loadings obtained for the two. Regardless of a high lean loading value for E 23A-1, it is about 150% lower than the lean loading of MEA.

### Example 4—Cyclic Capacity Determination

Cyclic capacity is a measure of the effective quantity of CO₂ that is removed from the flue gas stream per volume of amine solvent composition used per a solvent composition circulation cycle. The difference between the solvent composition's rich and lean loading is used in the estimation of its cyclic capacity.

For each of the solvent compositions listed in Table 1, the cyclic capacity of the solvent composition based on the rich loading, the lean loading, and the molar concentration of the amine was determined. The cyclic capacity refers to how much CO₂ has been removed in a cycle. The cyclic capacity is calculated using Equation (5):

$$Cyclic Capacity ( CC ) [ mol {CO}_{2} / L \cdot solm ] = \frac{rich loading - lean loading , mol {CO}_{2}}{mol amine} \times [ Amine Concentration ] \qquad ( 5 )$$

For example, the Cyclic Capacity for 5M MEA is calculated as follows:

$$CC = \frac{0.37 - 0.24 mol CO 2}{mol amine} \times \frac{5 mol amine}{Lsoltn} = \frac{0.65 mol CO 2}{Lsoltn}$$

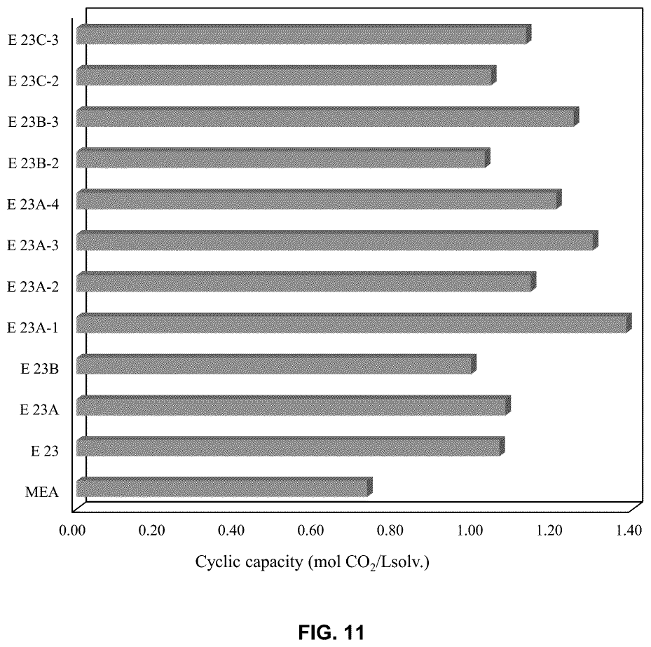

From the results illustrated in FIG. 11, E 23A-1 effectively removed the maximum amount of CO₂. It recorded a cyclic capacity of 1.38 mol CO₂/L of solvent composition which corresponds to about 30% enhancement relative to that of E 23. This was followed by E 23A-3 and E 23C-2 with cyclic capacities of 1.30 and 1.25 mol CO₂/L of solvent composition respectively. Of all the formulated solvent compositions, E 23B recorded the minimum cyclic capacity of about 1.0 mol CO₂/L of solvent composition.

The cyclic capacity of the various different solvent composition is shown in in FIG. 11 and listed in Table 3 below.

TABLE 3
Performance indicators of the proposed solvent compositions

| | Initial rate | Rich | Absorption | Initial rate | | Cyclic | | Desorption |
|---|---|---|---|---|---|---|---|---|
| | of absorp. | loading | parameter | of desorp. | Lean loading | Capacity | | parameter |
| Solvent | ×10⁻²(mol | (mol | ×10⁻³(mol | ×10⁻²(mol | (mol CO₂/mol | (mol | Heat Duty | ×10⁻² ((mol CO₂)³/ |
| composition | CO₂/min · L) | CO₂/L) | CO₂/min · L) | CO₂/min · L) | solv.) | CO₂/Lsolv) | kJ/CO₂ | (kJ · min · L²)) |
| MEA | 0.35 | 0.37 | 0.35 | 13.1 | 0.22 | 0.73 | 238.5 | 0.04 |
| E 23 | 0.41 | 0.31 | 0.41 | 47.8 | 0.05 | 1.06 | 65.3 | 0.78 |
| E 23A | 0.39 | 0.33 | 0.39 | 41.8 | 0.06 | 1.08 | 74.6 | 0.61 |
| E 23B | 0.32 | 0.28 | 0.32 | 35.3 | 0.03 | 0.99 | 88.4 | 0.40 |
| E 23A-1 | 0.4 | 0.39 | 0.40 | 45.5 | 0.09 | 1.38 | 68.6 | 0.92 |
| E 23A-2 | 0.41 | 0.30 | 0.41 | 41.3 | 0.04 | 1.14 | 75.5 | 0.63 |
| E 23A-3 | 0.38 | 0.32 | 0.38 | 31.2 | 0.06 | 1.30 | 99.8 | 0.41 |
| E 23A-4 | 0.37 | 0.35 | 0.37 | 27.3 | 0.10 | 1.21 | 114.2 | 0.29 |
| E 23B-2 | 0.35 | 0.29 | 0.35 | 35.9 | 0.03 | 1.03 | 86.8 | 0.42 |
| E 23B-3 | 0.38 | 0.33 | 0.38 | 40.2 | 0.03 | 1.25 | 77.6 | 0.65 |
| E 23C-2 | 0.37 | 0.30 | 0.37 | 44.6 | 0.04 | 1.04 | 69.9 | 0.66 |
| E 23C-3 | 0.35 | 0.32 | 0.35 | 25.6 | 0.05 | 1.13 | 122.0 | 0.24 |

### Example 5—Absorption/Desorption Parameter Determination

A method of measuring the performance of the various solvent compositions was developed. The method involved combining the various performance criteria into an absorption parameter and a desorption parameter that can account for the absorption performance as well as the desorption performance. The absorption parameter was defined as the initial CO₂ absorption rate (10⁻² mol CO₂/L·soltn). The desorption parameter was defined as a combination of the desorption rate, the cyclic capacity and the regeneration heat duty as set out in Equation (6):

$$Desportion parameter = \frac{initial {CO}_{2} desorption rate \times cyclic capacity}{regeneration heat duty} \qquad ( 6 )$$

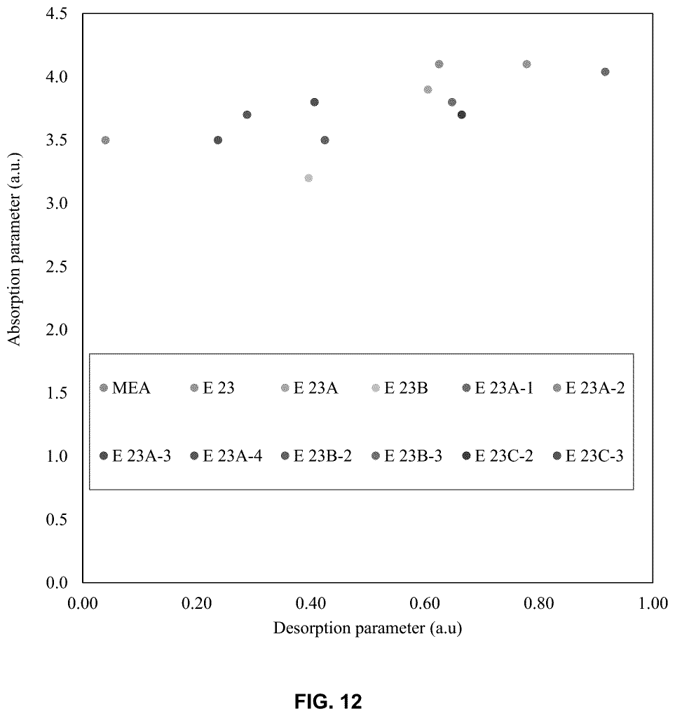

FIG. 12 shows absorption performance plotted against desorption performance (i.e., based on the Absorption Parameter and the Desorption Parameter) for the solvent compositions listed in Table 1. Solvent compositions at the top right corner are solvent compositions with both high absorption performance as well as high desorption performance. The figure summarizes the absorption and desorption performance of all the amines tested. From the figure, E 23A-1 appears as the optimum solvent composition given that it had the best balance between the absorption and desorption parameters. A summary of all the absorption and desorption screening results is tabulated in Table 3.

### Vapor Pressure

The vapor pressure for some formulated solvent compositions were determined using an autoclave reactor by varying autoclave temperature from 40 to 120° C. Also, pursuant to lack of available vapor pressure data for pure amine compounds, each of the components constituting the different blends excluding PEI and HMDA were tested for their vapor pressures. For the pure components, high temperature range could not be considered due to the relatively low flash point values recorded for some components. For 100% MEA, the temperature range considered was from 25 to 85° C., while that of 100% PR and 100% D were analyzed from 25 to 45° C.

In the experiment, the pure components recorded almost the same vapor pressures at all temperatures. This could be due to the relatively poor sensitivity of the autoclave reactor to low temperature range. It was determined from the results obtained that solvent composition E 23 recorded the highest vapor pressures at all temperatures while there was no significant variation between the vapor pressures of MEA and E 23A-1. With this observation, the high amine volatility loss setback associated with E 23 is validated and it could therefore be deduced that, the volatility loss when E 23A-1 solvent composition is used industrially is expected to be significantly lower than the loss recorded for the E 23 solvent composition. Consequently, operating cost emanating from frequent fresh solvent composition make-up due to high solvent composition volatility would be reduced considerably.

### Density

The density of a number of solvent compositions were measured using Anton Paar's DMA 4500 M density meter with an accuracy of 0.00001 g/cm3 for density and 0.01° C. for temperature. A liquid sample with a volume of approximately 3 ml was used to take the density reading and a new sample was fed into the U-tube for density measurements at each temperature, ensuring that there were no bubbles in the U-tube. Before injection of the sample, the equipment was cleaned with distilled water and acetone and well dried. The density of each sample was measured three times and the average of the readings recorded as the result.

The temperature was varied from 40 to 600C, and the density of each of the solvent compositions, as well as water was determined, and the results were collected. From the data obtained, density measurements obtained for the optimum E 23A-1 solvent composition were lower than that of MEA but higher when evaluated against E 23 values at the different temperatures.

### Viscosity

An Anton Paar's Lovis 2000 M/ME rolling-ball micro viscometer with accuracy of +0.5% for viscosity and 0.02° C. for temperature was employed in the measurement of the solvent composition viscosity. The viscometer measured solvent composition viscosity by measuring the rolling time of a ball through the sample based on Hoeppler's falling ball principle. Samples were carefully prepared and introduced to the X sampler to be introduced to the Lovis 2000 as the temperature conditions were set. The result for each sample was obtained as an average of three measurements. Temperature was varied from 40 to 60° C. and viscosity measurements were. The data from the results obtained shows higher viscosity measurements for E 23A-1 in comparison to MEA or Entropy 23 at all temperatures. This observation is explained based on increased concentration of component H in its formulation. H Concentration in the optimum solvent composition is higher than that in E 23 by a factor of 2.5.

### Heat Capacity

Heat capacity is the quantity of heat absorbed per unit mass of the material when its temperature increases 1 K (or 1° C.). The heat capacities for each one of solvent compositions E 23A-1, E 23, MEA and E 23B-1 were evaluated. From the results obtained, it was determined that, when compared to MEA and E 23, lower heat capacity values were recorded as a function of temperature for E 23A-1. This trend analysis of the solvent composition heat capacity studies indicates that, when compared, less thermal energy would be required for the regeneration of the optimum E 23A-1 solvent composition. With this observation, enormous savings on the capital cost of the lean-rich (L-R) heat exchanger could be realized given its reduced size.

### Example 6-Pilot Plant Experiments

Further to the batch-scale laboratory glassware screening investigation, continuous full-cycle mini-pilot plant runs were conducted to validate the performance and to access the industrial suitability of the optimum E 23A-1 solvent composition. Separate control runs with MEA and E 23 solvent compositions were also carried out. Typical experimental process conditions employed for the full-cycle runs are given below in Table 4.

TABLE 4
Experimental Process Conditions

| Condition | Value | Unit |
|---|---|---|
| Feed gas rate | 35 ± 1 | slpm |
| CO₂ Conc. | 4 ± 0.3 | % |
| Feed gas inlet temp. | 40 ± 1 | ° C. |
| Lean amine flowrate | 50 ± 2 | ml/min |
| Lean amine temperature | 33 ± 2 | ° C. |
| Reboiler temperature | 110 ± 2 | ° C. |
| Run duration | 24 | hr |
| Solvent compositions | MEA | |
| | Entropy 23 | |
| | Entropy 23A-1 | |

As desired and presented in Table 4, the simulated feed gas was introduced at a desired mean temperature of 40±1° C. for each performance run. Validated by results in Table 5, while MEA had the highest CO₂ rich loading per cycle, it is limited by its low cyclic capacity (indicating a higher MEA circulation rate) and higher regeneration energy cost. Moreover, E 23 solvent composition outperformed E 23A-1 in terms of lean loading and desorber-side mass transfer coefficient, yet, higher cyclic capacity, lower heat duty and, more importantly, low vaporization rate were measured for E 23A-1.

Notwithstanding the high gas-to-liquid ratio (G/L=700) utilized, a significant CO₂ removal efficiency of 95% was measured for E 23A-1 solvent composition. As seen in Table 6, this represents about 32% and 23% enhancements relative to the evaluated efficiencies for MEA and E 23 respectively. When compared, the higher gas-phase mass transfer coefficient (K_{G}aᵥ) measured for E 23A-1 accounted for its higher CO₂ absorption efficiency. The higher the K_{G}aᵥ, the faster the transfer rate of CO₂ molecules from bulk gas phase to the aqueous phase, hence, a higher CO₂ absorption efficiency. Also, the leaner the lean solvent composition (which is an indication of higher K_{L}aᵥ) is, the higher the ability of the solvent composition to absorption more CO₂ from the bulk flue gas stream. Furthermore, the E 23A-1 solvent composition resulted in a substantial reduction in the regeneration heat duty. In comparison to heat duty for MEA, a 35% reduction was observed for E 23A-1 solvent composition regeneration heat duty. Table 6 reports the absolute percentage enhancement (+) or percentage reduction (−) for E 23A-1 relative to MEA or E 23 and for E 23 relative to MEA.

TABLE 5
summarized results of full-cycle performance experiments in a mini-pilot plant.

| | | | % Enhancement |
|---|---|---|---|
| Parameter | MEA | E 23A-1 | relative to MEA |
| K_{G}aᵥ (kmol/hr · m³ · kPa) | 0.63 | 1.48 | 135 |
| K_{L}aᵥ (hr⁻¹) | 0.81 | 1.95 | 141 |
| CO₂ Absorption Efficiency (%) | 72 | 95 | 32 |
| CO₂ Removal Rate ×10⁻³ (kg CO₂/hr) | 110.6 | 145.1 | 31 |
| Reboiler Heat Duty (GJ/tonne CO₂) | 23 | 15 | −35 (reduction in |
| | | | heat duty) |
| Lean Loading (mol CO₂/mol solv.) | 0.21 | 0.09 | 57 |
| Cyclic Capacity (mol CO₂/mol solv.) | 0.17 | 0.25 | 47 |

TABLE 6
Relative enhancements/reduction in performance indicators measured for E 23A-1.

| | % Enhancement 1 relative to; of E | | |
|---|---|---|---|
| | 23A-1 | | % Enhancement of E |
| Parameter | MEA | E 23 | 23 relative to MEA |
| K_{G}aᵥ (kmol/hr · m³ · kPa) | 135% | 106% | 14% |
| K_{L}aᵥ (hr⁻¹) | 141% | −55% | 435% |
| CO₂ Absorption Efficiency (%) | 32% | 23% | 7% |
| CO₂ Removal Rate ×10⁻³ (kg CO₂/hr) | 31% | 22% | 8% |
| Reboiler Heat Duty (GJ/tonne CO₂) | −35% | −29% | −9% |
| Rich Loading (mol CO₂/mol solv.) | −11% | 42% | −37% |
| Lean Loading (mol CO₂/mol solv.) | 57% | −350% | −90% |
| Cyclic Capacity (mol CO₂/mol solv.) | 47% | 14% | 30% |

Negative value indicates a reduction in activity.

### Oxidative Degradation and Ammonia Emission of the Solvent Compositions

Solvent composition improvement is one of the primary ways that can be used to effectively improve the efficiency of the amine-based post-combustion capture process. Experiments were conducted to test the degradation of amines and NH₃ emissions of the improved E23A-1. For comparison with the previous solvent compositions, the experiment also included the following solvent compositions: E23 solvent composition; 5M MEA; 3.6M D; 3.6M PR; and EN23 (with 100% N₂).

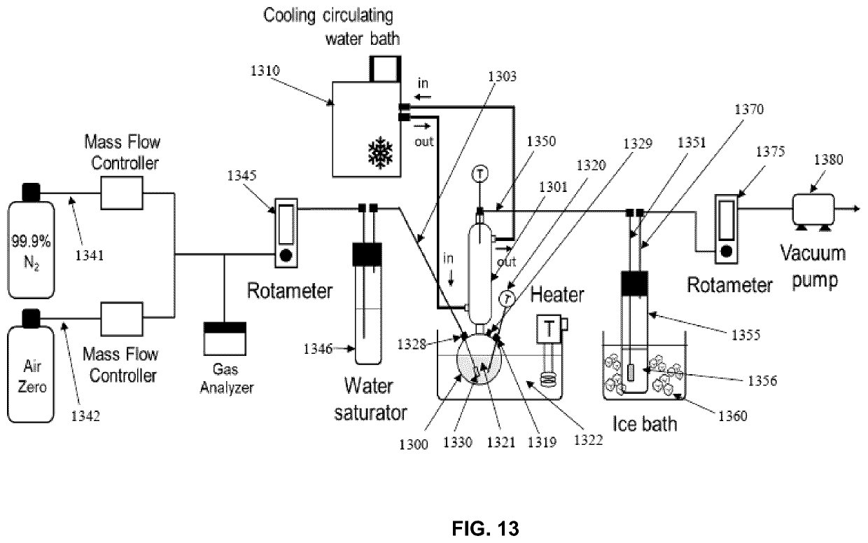

The oxidative degradation reaction of 250 ml CO₂-loaded amine solution was carried out at 60° C. for 28 days. The oxidative reaction was performed using 10% O₂ under nitrogen balance which was regulated at the flow rate of 200 mL/min. The off-gas ammonia (NH₃) produced by the degradation reaction was collected in the impinger set by means of acid-base reaction with 0.05M H₂SO₄. The amine solution and NH₃ emission samples were collected every single day until 28 days where the experiment was terminated. The samples were analyzed for concentrations of amine and NH₃ which were further used to determine amine degradation and NH₃ emission rates. The experimental set-up for oxidative degradation of amine solutions is shown in FIG. 13. The experimental conditions for the degradation study are shown in Table 7.

The experimental set-up shown in FIG. 13 involved a 500 mL four-necked round-bottom reaction flask 1300. The central neck of this flask 1300 was connected to a condenser 1301 equipped with a cooling circulating bath 1310. The outlet temperature of the condenser 1301 was maintained at the same temperature as the inlet feed gas 1303 (room temperature) to maintain moisture balance within the reaction flask 1300. The second neck 1319 was fitted with a thermometer 1320 using a thermometer adapter for measuring the temperature of the amine solution 1321. A diffuser tube 1330 was inserted through the third neck 1328 to bubble the feed gas 1303 into the amine solution 1321. The last neck 1329 was closed with a glass stopper. Before starting the experiment, 250 mL of CO₂-loaded amine solution 1321 at a certain concentration was placed in the reaction flask 1300 and warmed up to 60±2° C. in a temperature-controlled water bath 1322. A certain feed gas composition of N₂ 1341 and air 1342, regulated by a rotameter 1345 (0-500 ml/min±1.5% error, AALBORG, model GFC-17) at the flow at 200±2 mL/min, was verified using a bubble flow meter (Agilent Optiflow 420 Model). The feed gas 1303 was bubbled through a water saturator 1346 before the reaction flask 1300. The degradation reaction began once the feed gas 1303 was bubbled in the amine solution 1321.

Off-gas NH₃ produced from the reaction was collected by the connecting outlet 1350 of the condenser 1301 to the inlet 1351 of an impinger bottle 1355 filled with 50 mL of 0.05M H₂SO₄ 1356 to trap the NH₃ molecules. The impinger bottle 1355 was in an ice bath 1360 at a temperature below 5° C. for the whole time during sampling to assist the NH₃ being collected in the impinger solution 1356. To ensure a consistent off-gas flow rate through the impinger bottle 1355, preventing under- or oversampling, the impinger bottle's outlet 1370 was connected to a rotameter 1375 and then a vacuum pump 1380. The rotameter 1375 was maintained at a regulated flow of 200±2 mL/min, matching the feed gas flow rate setting.

TABLE 7
Experimental conditions of oxidative degradation
study on selected amine solvent compositions
Experimental condition

| | |
|---|---|
| Solvent volume (mL) | 250 |
| Degradation temperature (° C.) | 60 |
| Feed gas composition (vol %) | 10% O₂ |
| | 100% N₂ (baseline run) |
| Feed gas flow rate (mL/min) | 200 |
| Period (days) | 28 |

The concentrations of amine solution samples were analyzed by GC-MS. The GC-MS operating method and parameters for amine analysis are shown in Table 8. GC-MS method 1 was used for MEA solvent and method 2 was for EN23, EN23A, 3.6M PR, and 3.6M D solvents.

TABLE 8
GC-MS Method and Parameter

| GC-MS Parameter | Method 1 | Method 2 |
|---|---|---|
| Injection temperature (° C.) | 250° C. | |
| Carrier gas (He) flow rate | 1.4 mL/min | |
| Split ratio | 50:1 | |
| Initial temperature | 70° C. for 5 min | 100° C. for 2 min |
| Heating rate (° C./min) | 10° C./min | 30° C./min |
| Final temperature | 170° C. for 2 min | 220° C. for 6 min |

| | |
|---|---|
| GC-MS interface | 250° C. |
| MS quad | 150° C. |
| MS Source | 230° C. |
| EM voltage | 1858 |
| Mass range | 10-550 |

### NH₃ Emission Determination

The amount of NH₃ trapped in the impinger solution was analyzed by Roy Romanow Provincial Lab (Regina, Saskatchewan, Canada) using the Ammonia/Nitrate Analyzer (Timberline Model TL-2800) whose analysis was based on the principle of gas diffusion across a membrane coupled with an electrical conductivity measurement. The amount of NH₃ in the sample solution in mg/L obtained from the analysis was converted to its corresponding volume concentration of NH₃ gas (CNH₃, ppmV) in the off-gas using the Equation (7) below:

$${C}_{NH 3} ( ppmV ) = \frac{( \frac{mg}{L} of NH 3 ) ( 0.1 ) ( 24.04 ) ( 0.0 \; 01 ) {10}^{6}}{12 L \times 17 g / mol} \qquad ( 7 )$$

The concentrations of NH₃ (ppmV) and their corresponding times were used to generate a plot whose areas under the curve at different time intervals were calculated using Mathlab software (R2017a version). The obtained areas, representing the accumulated amounts of NH₃, were then plotted against their corresponding times to generate the NH₃ emission profile, whose slope represented the overall rate of NH₃ emissions produced by each amine solution.

### Water and Amine Vaporization Determination

Due to the vaporization of water and amine during the experiment affecting the analysis of degradation rate of amine, rates of water and amine vaporization for all the runs were determined and quantified. The water and amine vaporization data then was used to readjust the actual amount of amine that was degraded by the oxidative reaction only. The water loss rate, was determined by dividing the difference between the starting volume (250 mL) and the final volume of amine solution by 28 days of the experiment (1 mL a day) as shown in Equation (8) below:

$$rate of water vaporization ( \frac{mL}{day} ) = \frac{\begin{matrix}( Started volume - \\ Final volume - \\ Sample taked volume )\end{matrix}}{Experimental days} \qquad ( 8 )$$

For amine vaporization, the amine vapor in the off-gas stream was collected for the period of 6 hr by condensing it into an empty impinger which was soaked in the iced bath at 5° C. throughout the test. The condensed liquid was transferred to a 10 mL volumetric flask and adjusted the volume with DI water. The amount of amine in the collected samples was quantified by using GC-MS. The vaporization rates of amine (mmol/day) and water (mL/day) were used to correct the amine degradation rate results.

The examples and corresponding diagrams used herein are for illustrative purposes only. The principles discussed herein with reference to determination of equilibrium dissociation constants can be implemented in other systems and apparatuses. Different configurations and terminology can be used without departing from the principles expressed herein. For instance, steps, equipment, components, and modules can be added, deleted, modified, or re-arranged without departing from these principles.

The oxidative degradation and NH₃ emission of 5M MEA, 3.6M D, and 3.6M PR single amines and EN23 and EN23A1 blended amines were studied to determine the stability of the solvent compositions while being used to capture the CO₂. In addition to the experiments carried out at 60° C. using 10% O₂ with a flow rate of 200 mL/min for all the amines previously described, an extra run was carried out on EN23 solvent composition with 100% N₂. This experiment was used as a baseline run to help establish the true degradation rate of EN23. The rates of amine degradation and NH₃ emission of other solvent compositions are also shown in Table 9.

As mentioned previously, the amine degradation rate determined from the experiment could be faulty if the amine and water vaporization during the experiment are not accounted for. Therefore, rates of water and amine losses via vaporization were measured and used to re-calculate the actual rates of amine degradation that were caused only by the oxidative degradation.

Table 9 summarizes the rates of water and amine loses. The rates of water losses by vaporization in the off-gas of 5M MEA, 3.6M D, 3.6M PR, EN23 (with 100% N₂), EN23, and EN23A1 solvent compositions were 1.60, 1.39, 0.31, 1.40, 1.96, and 1.53 mL/day, respectively. The amine vaporization rates of 5M MEA, 3.6M D, 3.6M PR, EN23 (with 100% N₂), EN23, and EN23A1 solvent compositions also reported in Table 9 were found to be 0.798, 7.059, 0.725, 4.918, 5.490, and 0.705 mmol/day, respectively. It must be pointed out that the amine vaporization rate of EN23A1 measured based on PR component was much lower than that E23 measured based on the D component. This is a substantial improvement in reducing the rate of amine vaporization of E23 to that of E23A1 by replacing the D component to the PR. The rate of amine loss of E23A1 was also very similar to that of MEA in the benchmark MEA solvent.

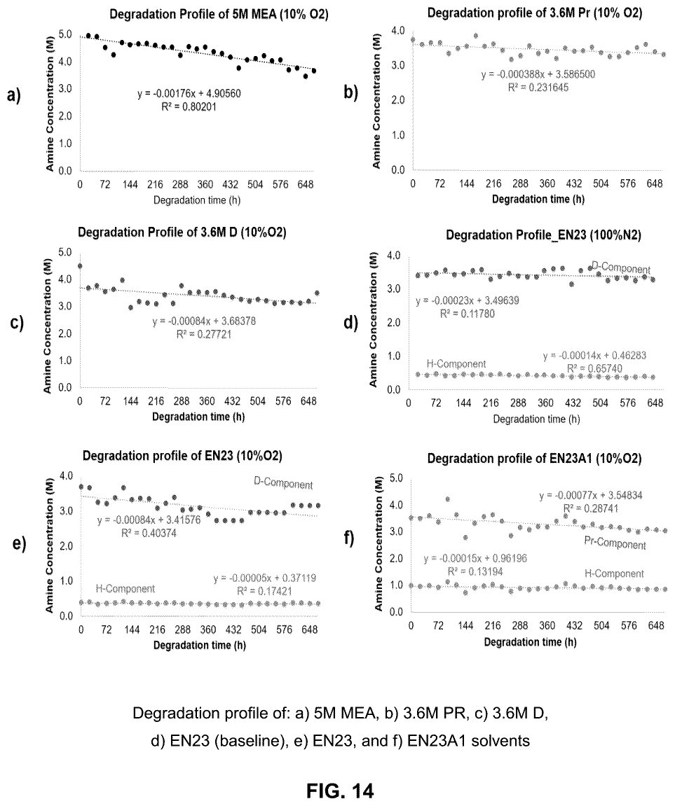

By taking to account the rates of water and amine losses in degradation rate calculations, the actual degradation rates of 5M MEA, 3.6M D, 3.6M PR, EN23 (with 100% N₂), EN23, and EN23A1 solvent compositions were determined and listed in Table 9. 5M MEA showed the degradation rate of 1.76 mM/h which was higher than the EN23 and EN23A1 by 52% and 56%, respectively. Degradation rate of 3.6M D was 0.84 mM/h which was closed to that of EN23 (0.84 mM/h) that had D as the main component. For 3.6M PR, the degradation rate was only 0.388 mM/h while EN23A1 having the PR as the main component showed the degradation rate of 0.77 mM/h. For the degradation of the H component in solvent compositions EN23 and EN23A1, the degradation rates were minuscule which were measured to be only 0.05 and 0.15 mM/h in EN23 and EN23A1, respectively. The degradation profiles of all tested amine solvent compositions are also shown in FIG. 14.

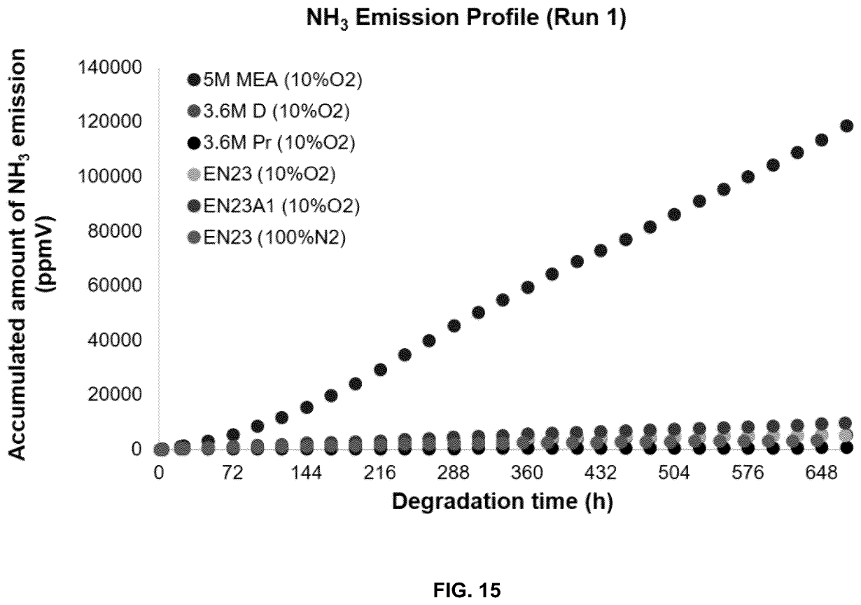

The overall rate of NH₃ emission is also reported in Table 9. 5M MEA showed the highest NH₃ emission rate at 183.06 ppmV/h. Solvent compositions EN23 and EN23A1 emitted NH₃ at the rate of 8.24 and 14.35 ppmV/h which were much less than the NH₃ released by the 5M MEA by 95% and 92%, respectively. For 3.6M D and 3.6M PR, they were found to emit NH₃ at a rate of 8.23 and 0.89 ppmV/h. FIG. 15 shows the NH₃ emission profiles of all tested amine solvent compositions.

TABLE 9
Degradation rate, NH₃ emission rate, water vaporization rate, and
amine vaporization rate comparison of amine solvent compositions

| | | | Water | Amine |
|---|---|---|---|---|
| | Degradation rate | NH₃ emission | vaporization rate | vaporization rate |
| Solvent composition | (mM/h) | rate (ppm V/h) | (mL/day) | (mmol/day) |
| 5M MEA-10% O₂ | 1.76 | 183.06 | 1.60 | 0.798 |
| 3.6M D-10% O₂ | 0.84 | 8.23 | 1.39 | 7.059 |
| EN23-10% O₂ | 0.84 (D), 0.05 (H) | 8.24 | 1.96 | 5.490 (D) |
| EN23-100% N₂ | 0.23 (D), 0.14 (H) | 5.03 | 1.40 | 4.918 (D) |
| 3.6M PR-10% O₂ | 0.388 | 0.98 | 0.31 | 0.725 (PR) |
| EN23A1-10% O₂ | 0.77 (PR), 0.15 (H) | 14.35 | 1.53 | 0.705 (PR) |

Solvent composition E 23A-1 with a molar concentration of 4.61M was identified amidst rigorous testing and analysis as a highly desirable solvent composition for carbon capture. Beyond the batch-scale glassware solvents screening, data obtained from a full-cycle performance analysis of E 23A-1 in a bench-scale mini-pilot plant (50 m3/day) confirmed its excellent capture performance.

Moreover, on average, the maximum CO2 capture efficiency (95%), highest cyclic capacity (indicating a lower solvent circulation rate) and the least regeneration consumption energy (15 GJ/tonne CO2) were recorded for solvent composition E 23A-1.

Furthermore, owing to the precipitation tendency of H component in solvent composition E 23A-1, its concentration should preferably be kept below 1.2 M during large-scale industrial operations. Also, given the pungent smell of component PR in the solvent composition E 23A-1, it is preferable to introduce an acid wash on the treated off gas stream to minimize or possibly eliminate all PR component emissions.

Unless the context clearly requires otherwise, throughout the description and the claims: “comprise,” “comprising,” and the like are to be construed in an inclusive sense, as opposed to an exclusive or exhaustive sense; that is to say, in the sense of “including, but not limited to”. “Herein,” “above,” “below,” and words of similar import, when used to describe this specification shall refer to this specification as a whole and not to any particular portions of this specification. “Or” in reference to a list of two or more items, covers all of the following interpretations of the word: any of the items in the list, all of the items in the list, and any combination of the items in the list. The singular forms “a”, “an”, and “the” also include the meaning of any appropriate plural forms.

Where a component is referred to above, unless otherwise indicated, reference to that component should be interpreted as including as equivalents of that component, any component which performs the function of the described component (i.e., that is functionally equivalent), including components which are not structurally or compositionally equivalent to the disclosed structure or composition which performs the function in the illustrated exemplary implementations of the invention.

Specific examples of compositions, systems, methods and apparatuses have been described herein for purposes of illustration. These are only examples. Many alterations, modifications, additions, omissions and permutations are possible within the practice of this invention. This invention includes variations on described compositions that would be apparent to the skilled addressee, including variations obtained by: replacing features, elements and/or chemical compounds with equivalent features, elements and/or chemical compounds; mixing and matching of features, elements and/or chemical compounds from different examples; combining features, elements and/or chemical compounds from examples as described herein with features, elements and/or chemical compounds of other technology; omitting and/or combining features, elements and/or chemical compounds from described examples.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

1. A solvent composition for extracting carbon dioxide from a gaseous mixture, the solvent composition comprising:
(a) a first component selected from the group consisting of: diethylaminoethanol; 1-(2-hydroxhyl) pyrrolidine; 3-diethylamino-1,2-propanediol; 3-diethylamino-1-propanol; 1-diethylamino-2-propanol and combinations thereof; and
(b) a second component selected from the group consisting of: hexamethylenediamine (HMDA); 4-amino-1-butanol and combinations thereof.

2. The composition as claimed in claim 1, further comprising a polyethylenimine (PEI).

3. A composition for extracting carbon dioxide from a gaseous mixture, the composition comprising 1-(2-hydroxyethyl) pyrrolidine (PR), hexamethylenediamine (HMDA), and water.

4. The composition as claimed in claim 3, further comprising a polyethylenimine (PEI).

5. The composition as claimed in claim 3, wherein at least one of the following is present: PR is present in molar concentration ranging from 2.0M to 5.0M, HMDA is present in molar concentration ranging from 0.1M to 1.5M, or PEI is present in molar concentration ranging from 0.001M to 0.5M.

6. The composition as claimed in claim 3, wherein a total molar concentration of the solvent is in the range of 2.10M to 6.9M.

7. The composition as claimed in claim 3, consisting essentially of 1-(2-hydroxyethyl) pyrrolidine (PR), hexamethylenediamine (HMDA), a polyethylenimine (PEI), and water.

8. The composition as claimed in claim 7, wherein 1-(2-hydroxyethyl) pyrrolidine (PR) is present in molar concentration of 3.6M, wherein HMDA is present in molar concentration of 1.0M, and wherein PEI is present in molar concentration of 0.01M.

9. The composition as claimed in claim 3, having at least one of the following properties: a heat duty below 160 kJ/mol CO₂, an initial absorption rate greater than
$$0.25 \frac{1 {0}^{- 2} * kJ mol {CO}_{2}}{L \cdot soltn * min} ,$$
an initial desorption rate greater than
$$1 8. \frac{1 {0}^{- 2} * kJ mol {CO}_{2}}{L \cdot soltn * min} ,$$
a cyclic capacity greater than
$$0.95 \frac{mol {CO}_{2}}{L \cdot soltn} ,$$
a lean loading of less than 0.5 at 110° C., a viscosity below 10 mPa·s at 30° C., and an alkalinity in the range of 9.5 to 11.0 pKa at room temperature.

10. The composition as claimed in claim 3, having at least one of the following properties: a heat duty below 120 kJ/mol CO₂, an initial absorption rate greater than
$$0 \text{.40} \frac{1 {0}^{- 2} * kJ mol {CO}_{2}}{L \cdot soltn * min} ,$$
an initial desorption rate greater than
$$3 5. \frac{1 {0}^{- 2} * kJ mol {CO}_{2}}{L \cdot soltn * min} * ,$$
a cyclic capacity greater than
$$1.05 \frac{mol {CO}_{2}}{L \cdot soltn} ,$$
a lean loading of 0 at 110° C., and an alkalinity in the range of 9.5 to 11.0 pKa at room temperature.

11. A composition for extracting carbon dioxide from a gaseous mixture, the composition comprising 1-(2-hydroxyethyl) pyrrolidine (PR), hexamethylenediamine (HMDA), and a polyethylenimine (PEI), wherein PR is present in molar concentration ranging from 3.0M to 5.0M and wherein HMDA is present in molar concentration ranging from 0.1M to 1.5M.

12. The composition as claimed in claim 11, wherein PR is present in molar concentration ranging from 3.3M to 3.9M, HMDA is present in molar concentration ranging from 0.5M to 1.2M, and PEI is present in molar concentration ranging from 0.005M to 0.015M.

13. The composition as claimed in claim 11, wherein PEI is present in molar concentration of 0.01M.

14. A method of using the composition as claimed in claim 1, to perform carbon capture comprising the steps of:
(a) collecting a flue gas comprising carbon dioxide from a flue gas emitting source; and
(b) exposing the collected flue gas to the composition of claim 1 for a period of time sufficient to remove at least a portion of said carbon dioxide gas present in said flue gas.
